(19) United States
(12) Patent Application Publication
(10) Pub. No.: US 2012/0290976 A1
(43) Pub. Date: Nov. 15, 2012

(54) NETWORK DISTRIBUTION OF ANATOMICAL MODELS

(75) Inventors: Ryan Phillip Lahm, Lino Lakes, MN (US); Josee Morissette, Eden Prairie, MN (US); Michael J. Schendel, Andover, MN (US); Christopher H. Johnson Bidler, Columbia Heights, MN (US); Walton W. Baxter, III, San Clemente, CA (US); Karel F.A.A. Smits, Munstergeleen-Limburg (NL)

(73) Assignee: MEDTRONIC, INC., Minneapolis, MN (US)

(21) Appl. No.: 13/107,794

(22) Filed: May 13, 2011

(51) Int. Cl. G06F 3/048

(52) U.S. Cl. 715/810

(57) ABSTRACT

Techniques for presenting a three-dimensional (3D) anatomical representation of an anatomical structure are described. 3D models of various anatomical structures may be stored as prepackaged anatomical data. A user device, e.g., a networked workstation, may receive the prepackaged anatomical data from a networked computing device, e.g., a server, and present at least a portion of a 3D model as a 3D anatomical representation. The user device may also present a menu with the 3D anatomical representation that allows the user to manipulate the 3D anatomical representation and measure various aspects of the 3D anatomical representation. In some examples, the user device may also present a representation of a medical device in conjunction with the 3D anatomical representation.

### TECHNICAL FIELD

The invention relates to anatomical data, and, more particularly, to presenting anatomical data to a user.

### BACKGROUND

Human anatomy can be digitally visualized using a variety of imaging techniques. Magnetic resonance imaging (MRI), computed tomography (CT), and positron emission tomography (PET) are just some examples of imaging techniques used to image anatomical structures of a patient. Since this imaging data may be representative of the anatomy in three-dimensions, a computer may be used to generate or render a three-dimensional (3D) image. The 3D image is rendered based on the imaging data received from the scanning device used to generate the imaging data. A clinician or researcher may then use this 3D image to visualize anatomy in vivo to diagnose a patient disorder or otherwise investigate the imaged anatomy.

### SUMMARY

Generally, this disclosure describes various techniques for presenting a three-dimensional (3D) anatomical representation of an anatomical structure. 3D representations of patient anatomy may be generated using data from a variety of non-invasive imaging techniques. However, a specially trained technician may be required to render desired 3D representations using the raw imaging data and derive usable information from the 3D representations using a single workstation. These 3D images may thus be generally inaccessible to clinicians, researchers, and engineers in the healthcare industry who could benefit from the information provided in the 3D images.

As further described herein, 3D models of various anatomical structures may be stored as prepackaged anatomical data that may be distributed over a network to a user. In other examples, the prepackaged anatomical data may be distributed using a physical media, e.g., a digital versatile disk (DVD) or flash drive. This prepackaged anatomical data may include 3D models of one or more anatomical structures. Example anatomical structures may include healthy or diseased examples of a heart, a brain, a spinal cord, pelvic floor structures, or other organs. A user device, e.g., a networked workstation, may receive the prepackaged anatomical data from a networked computing device, e.g., a server. The user device may then present at least a portion of a 3D model defined by the prepackaged anatomical data as a 3D anatomical representation. In this manner, the user device presents 3D models instead of generating 3D representations from raw data.

The user device may also present a menu with the 3D anatomical representation that allows the user to manipulate the 3D anatomical representation and measure various aspects of the 3D anatomical representation. The user may investigate and utilize the 3D anatomical representation to better understand the structure and function of the anatomy. In some examples, the user device may also present a device representation of a medical device in conjunction with the 3D anatomical representation. The device representation may allow the user to design or modify new medical devices within the space of the 3D anatomical representation.

In one example, the disclosure describes a method that includes receiving prepackaged anatomical data, wherein the prepackaged anatomical data comprises one or more pre-defined three-dimensional (3D) models of one or more respective anatomical structures, presenting at least a portion of the one or more 3D models as a 3D anatomical representation, presenting a menu with the 3D anatomical representation, wherein the menu comprises manipulation control of the 3D anatomical representation and measurement tools, receiving a manipulation control input, and manipulating the 3D anatomical representation according to the manipulation control input.

In another example, the disclosure describes a device including a processor configured to receive prepackaged anatomical data, wherein the prepackaged anatomical data comprises one or more pre-defined three-dimensional (3D) models of one or more respective anatomical structures. The device also includes a user interface configured to present at least a portion of the one or more 3D models as a 3D anatomical representation, present a menu with the 3D anatomical representation, wherein the menu comprises manipulation control of the 3D anatomical representation and measurement tools, receive a manipulation control input, and manipulate the 3D anatomical representation according to the manipulation control input.

In another example, the disclosure describes a system including a data repository configured to store prepackaged anatomical data, wherein the prepackaged anatomical data comprises one or more pre-defined three-dimensional (3D) models of one or more respective anatomical structures, and a networked computing device configured to retrieve the prepackaged anatomical data from the data repository and transmit the prepackaged anatomical data to a user device via a network. The user device includes a communication module configured to receive the prepackaged anatomical data from the networked computing device, and a user interface configured to present at least a portion of the one or more 3D models as a 3D anatomical representation, present a menu with the 3D anatomical representation, wherein the menu comprises manipulation control of the 3D anatomical representation and measurement tools, receive a manipulation control input, and manipulate the 3D anatomical representation according to the manipulation control input.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual drawing illustrating an example system that distributes prepackaged anatomical data to a user computing device via a network.

FIG. 2 is a functional block diagram illustrating an example configuration of a user computing device of FIG. 1.

FIG. 3 is a conceptual drawing illustrating an example user interface for retrieving prepackaged anatomical data from a networked computing device.

FIG. 4-19 are conceptual drawing illustrating an example user interface that presents 3D anatomical representations and provides various tools to interact with the 3D anatomical representations.

FIG. 20 is a flow diagram of an example technique for presenting and manipulating a 3D anatomical representation from prepackaged anatomical data.

FIG. 21 is a flow diagram of an example technique for presenting a device representation of a medical device within the 3D anatomical representation.

FIG. 22 is a flow diagram of an example technique for transmitting prepackaged anatomical data to a user device via a network.

### DETAILED DESCRIPTION

This disclosure describes various techniques for presenting a three-dimensional (3D) anatomical representation of an anatomical structure. Non-invasive imaging techniques may be used to detect and identify anatomical structures within a patient. 3D representations of patient anatomy may then be generated using data from these non-invasive imaging techniques, e.g., magnetic resonance imaging (MRI), computed tomography (CT), and positron emission tomography (PET). Powerful 3D representations may be generated using the raw imaging data and used to derive technical information about the anatomy from the 3D representations. However, a trained technician may be required to collect and render the 3D representations and interact with the 3D representations. In addition, the large raw imaging data sets may be large and only usable by specific software on a particular workstation. These 3D images from patients may thus be generally inaccessible to clinicians, researchers, and engineers in the healthcare industry who could benefit from the information provided in the 3D images.

As described herein, 3D models of various anatomical structures may be stored as prepackaged anatomical data that may be distributed over a network to a user. Distribution of prepackaged anatomical data may provide accessible 3D models in a usable and interactive format. This prepackaged anatomical data may include 3D models of one or more anatomical structures from one or more patients. Example anatomical structures may include healthy or diseased examples of a heart, a brain, a spinal cord, pelvic floor structures, or other organs. A user device, e.g., a networked workstation, may receive the prepackaged anatomical data from a networked computing device, e.g., a server. The user device may then present at least a portion of a 3D model defined by the prepackaged anatomical data as a 3D anatomical representation. In this manner, the user device presents 3D models instead of generating and rendering 3D representations from raw data.

The 3D anatomical representations provided by the user computing device may allow the user to interact with the 3D anatomical representations. For example, the user computing device may present a menu with the 3D anatomical representation that allows the user to manipulate the 3D anatomical representation within three-dimensional space. As the 3D anatomical representation is manipulated, the user computing device may also present an orientation reference image, e.g., a human figure, that indicates the direction in which the user in viewing the 3D anatomical representation.

The user interface of the user computing device may also allow the user to measure various aspects of the 3D anatomical representation, e.g., distances or volumes within the 3D anatomical structure. In this manner, the user may investigate and utilize the 3D anatomical representation to better understand the structure and function of the anatomy. In addition, the user computing device may present a device representation of a medical device in conjunction with the 3D anatomical representation. The device representation may allow the user to design or modify new medical devices within the space of the 3D anatomical representation.

The prepackaged anatomical data described herein generally includes 3D model information that has been already generated from raw imaging data. In other words, the one or more 3D models included in the prepackaged anatomical data may allow the anatomical structures to be used without requiring networked devices to re-generate the 3D models from the original raw imaging data. The prepackaged anatomical data may also include additional information, such as metadata describing various information of the patient from which the 3D model was generated. The prepackaged anatomical data may also be converted to a format readable by software commonly installed on networked devices, such as a web browser.

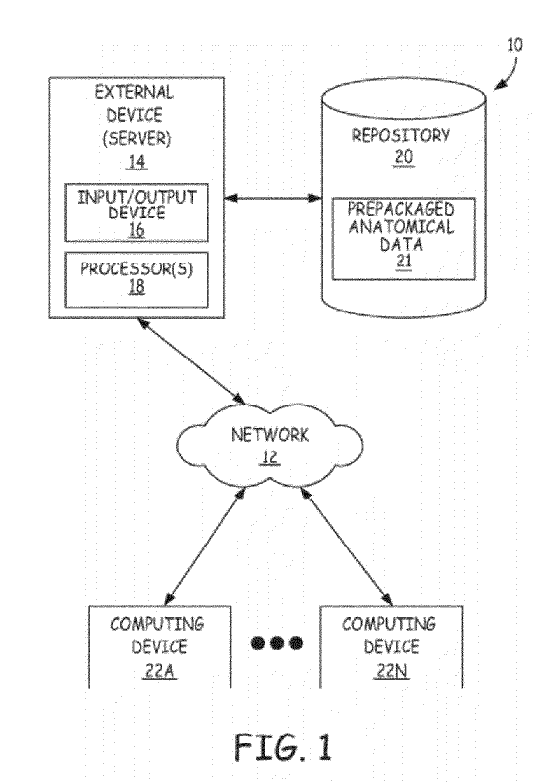

FIG. 1 is a conceptual drawing illustrating example system 10 that distributes prepackaged anatomical data 21 to user computing devices 22 via network 12. As shown in FIG. 1, system 10 includes network 12, an external computing device, such as server 14, repository 20, and one or more computing devices 22A-22N. Network 12 may be generally used to distribute or transmit the prepackaged anatomical data 21 from repository 20 and server 14 to the one or more computing devices 22A-22N. Server 14 and user computing devices 22A-22N are interconnected, and able to communicate with each other, through network 12. Although data repository 20 may only be coupled directly to server 14, repository 20 may be networked to computing devices 22A-22N via network 12 in other examples. In some cases, server 14 and computing devices 22A-22N may be coupled to network 12 through one or more wireless connections.

Server 14 and computing devices 22A-22N may each comprise one or more processors, such as one or more microprocessors, DSPs, ASICs, FPGAs, programmable logic circuitry, or the like, that may perform various functions and operations, such as those described herein. For example, server 14 may include a processor and/or other components configured to transmit prepackaged anatomical data 21 from data repository 20 to one or more of user computing devices 22A-22N. In another example, computing devices 22A-22N may include processors configured to receive prepackaged anatomical data 21 that includes 3D models and present a portion of a 3D model as a 3D anatomical representation.

Network 12 may be a local area network, wide area network, or the Internet. Server 14 and computing devices 22 may implement a secure communication protocol over network 12. In some cases, network 12 may provide a virtual private network for server 14 and computing devices 22. In some examples, access to network 12 and prepackaged anatomical data 21 stored in data repository 20 may be limited to those devices configured to establish a secured connection with network 12, e.g., each of computing devices 22A-22N. In other examples, network 12 may be implemented within a corporation or research facility with employees having access to prepackaged anatomical data 21 via computing devices 22A-22N.

Server 14 may be configured to provide a secure storage site for archival of prepackaged anatomical data 21, 3D models, or even the raw imaging data used to generate the 3D models of the prepackaged anatomical data 21. Although data repository 20 may store this information, server 14 may provide internal storage for prepackaged anatomical data 21, or other data, in other examples. Administrators, or users with access to the raw imaging data used to generate prepackaged anatomical data 21, may use input/output device 16 of server 14 to update or otherwise create prepackaged anatomical data 21. In this example, server 14 may be in communication with an imaging device, e.g., an MRI or CT scanner, that generates the raw imaging data of an anatomical structure from a patient. In other examples, an administrator may log into server 14 via network 12 to update or otherwise create prepackaged anatomical data 21. Processor(s) 18 of server 14 may generate prepackaged anatomical data 21, handle requests for prepackaged data, or otherwise distribute information stored in data repository 20 to user computing devices 22A-22N.

Data repository 20 may store any networked, distributed, or original data described herein. For example, data repository 20 may store raw imaging data of the anatomical structures, generated 3D models of the anatomical structures, prepackaged anatomical data 21, or any other related information. Data repository 20 may include one or more repositories that store applicable data. Data repository 20 may comprise of any type of storage medium. For example, data repository 20 may use one or more types of hard disk storage, magnetic tape, optical storage, electrical media, any non-volatile media (e.g., flash memory), or any other digital or analog storage media.

Computing devices 22A-22N may be any type of device configurable to present 3D anatomical representations from prepackaged anatomical data 21 and accept user input manipulating or otherwise interacting with the 3D anatomical representations. Computing devices 22A-22N may include one or more workstations, desktop computers, notebook computers, tablet computers, handheld computers, mobile communication devices, or any other computing device capable of providing the functions described herein. In this manner, computing devices 22A-22N may use commercially available or proprietary software language to open and interact with prepackaged anatomical data 21 received from server 14. These languages may be implemented in commercially available web browsers or other software environments designed to receive and transmit information via network 12.

As described herein, computing devices 22A-22N may be configured to receive prepackaged anatomical data 21 from another networked computing device (e.g., server 14) via network 12. Prepackaged anatomical data 21 may include one or more pre-defined (3D) models of one or more respective anatomical structures. The anatomical structures may be a structure imaged from a patient, and the pre-defined 3D models may be generated from the imaged anatomical structures. This generation of pre-defined 3D models and prepackaged anatomical data 21 may be completed with processor(s) 18 of server 14 or another computing device. A user interface (not shown) of one of computing devices 22A-22N may then be configured to present at least a portion of the one or more 3D models as a 3D anatomical representation, present a menu with the 3D anatomical representation, and receive a manipulation control input from the user that manipulates the 3D anatomical representation. The menu may include manipulation control of the 3D anatomical representation to change the viewed orientation of the 3D anatomical representation and measurement tools that allow the user to measure various aspects of the 3D anatomical representation.

In addition to the 3D representation, computing devices 22A-22N may present an orientation reference image that indicates a presented orientation of the 3D anatomical representation in relation to a respective human body. For example, the orientation reference image may be an image of a person that has an orientation pegged to that of the 3D anatomical representation.

The user interface of computing devices 22A-22N may also receive a selection input from the user that selects one of the one or more anatomical structures, e.g., a heart, a brain, vasculature, or pelvic floor structures. Once the selection input is received, computing devices 22A-22N may subsequently present a portion of the 3D model of the selected anatomical structure as the 3D anatomical representation. Although prepackaged anatomical data 21 may included 3D models of more than one anatomical structure to prevent retrieval of additional data, computing devices 22A-22N may need to retrieve additional or alternative prepackaged anatomical data 21 from server 14 based on the selection input. For example, if the originally received prepackaged anatomical data does not include the 3D model for the selected anatomical structure, the computing device may retrieve additional prepackaged anatomical data from server 14. In some examples, the available anatomical structures may include one or more healthy anatomical structure, e.g., a healthy heart, and one or more diseased anatomical structure, e.g., an enlarged heart due to heart failure.

Computing devices 22A-22N may also allow the user to measure various aspects of the 3D anatomical representation. Computing devices 22A-22N may present measurement tools in the menu that include at least one of a distance tool, an area tool, a volume tool, or an angle tool, as examples. The distance tool may be used to measure distance between two points, the area tool may be used to measure the area of a selected portion of the 3D anatomical representation, the volume tool may be used to measure a volume of a selected portion of the 3D anatomical representation, and an angle tool may be used to measure an angle between two lines created in the 3D anatomical representation.

To use any of these measurement tools, computing devices 22A-22N may first receive a measurement input that defines the measured, or selected, portion of the 3D anatomical representation. Computing devices 22A-22N may then calculate the measured portion based on the measurement input from one of the distance tool, the area tool, the volume tool, and the angle tool. Then, the computing device may present a visual identification and a numerical calculation of the measured portion of the 3D anatomical representation. The visual identification may be a graphic representation of the measured portion and the numerical calculation may be a value with specific units.

Although the measurements of the 3D anatomical representations may be interactive based on user selected endpoints within the representations, some measurements may be pre-calculated or pre-defined. For example, prepackaged anatomical data 21 may include volumes of heart chambers, densities of certain organs, or distances between common anatomical markers. Wide varieties of interactive or pre-calculated measurements may be provided, e.g., linear measurements, volume, cross-sectional areas, densities, or angles.

Computing devices 22A-22N may also present metadata related to the respective anatomical structure on which the presented 3D model is based. In other words, the user may view additional information related to the 3D anatomical representation being displayed. This metadata may include a height, a weight, a gender, an age, or a health status, of the patient associated with the generation of the 3D model from that patient's the anatomical structures. In some examples, the metadata may also include information related to the imaging process, e.g., imaging parameters, or the generation of the 3D model from the imaging data.

In other examples, certain users, e.g., administrators or selected users, may be allowed to add or update metadata about the 3D model. This updating ability may facilitate collaboration and the correction of errors or out of date information. For example, a user may have clearance to update a metadata field indicating which types of medical devices would meet the anatomical constraints of the particular 3D model.

Users may also utilize the 3D anatomical representations as guidelines to designing, troubleshooting, or otherwise engineering medical devices. Computing devices 22A-22N may present a device representation in relation to the 3D anatomical representation. This device representation may be at least a portion of a 3D model of the medical device selected by the user. The user may either select 3D models of various pre-defined medical devices, e.g., leads, pacemakers, defibrillators, drug pumps, stents, artificial joints, artificial valves, surgical tools, or other such devices, or generate new medical devices. To generate a new or modified 3D model of a medical device, computing devices 22A-22N may receive device modification input from the user that modifies one or more characteristics of the selected medical device. Computing devices 22A-22N may then update the 3D model based on the device modification input and presenting an updated device representation.

The user interface provided by computing devices 22A-22N to present the 3D anatomical representation may be simplified from interface environments used to generate the 3D models from the raw imaging data. In other words, computing devices 22A-22N may allow only minimal changes, if any, to the structure of the 3D model. Prepackaged anatomical data 21 that includes the 3D models may allow the computing devices 22A-22N to avoid any 3D generation at the user computing device.

In some examples, the 3D anatomical representations (or prepackaged anatomical data 21), may be integrated with computer-aided drafting software that generates 3D models of artificial items. For example, the user may utilize this drafting software to create or modify mechanical drawings of medical devices. Example drafting software that may be incorporated may include ProEngineer, SolidWorks, and AutoCAD. This integration of engineering tools and anatomical representations may help to guide and support medical device design decisions that relate to selected anatomical structures.

In other examples, prepackaged anatomical data 21 may include information for presenting dynamic motion of the 3D anatomical representation. This dynamic motion may be artificially animated during the creation of the 3D model or recreated from imaging data taken over time. In this manner, the user may view physiological motion of anatomical structures in vivo. Example motion may include wall motion of heart chambers, pulsatile motion of artery walls, joint motion, or even peristaltic waves in the gastrointestinal tract. Computing devices 22A-22N may still incorporate device representations within moving 3D anatomical representations. For example, the dynamic motion of the 3D anatomical representation may even indicate how the device would deform based on the pressures and forces created by the moving anatomy.

System 10 may also provide more interaction between the administrators who generate the 3D models and prepackaged anatomical data 21 from the imaged anatomical structures and the users who retrieve the prepackaged anatomical data. For example, the user may be able to deliver questions to the administrator about the particular anatomy, regarding updates to certain metadata, or even indications about missing or corrupt data. This communication between the user and administrator may occur over a live video or audio communication link via network 12 or via a networked text chat service. In addition, the user interface may allow the user to take a screenshot of the 3D anatomical representation and annotate the screenshot with comments or questions. This screenshot may then be delivered to the administrator who generated the 3D model from the imaging data of the anatomical structure. Administrators may also generate new 3D models of anatomical structures and deposit the representative prepackaged anatomical data 21 in data repository 20 for retrieval by another user.

Although 3D anatomical data is generally described as being distributed via a network to the user, the 3D anatomical data may be distributed to users using other methods. For example, the 3D anatomical data may be distributed using a physical medium. The user may receive the 3D anatomical data stored on a compact disc (CD), digital versatile disk (DVD), magnetic tape drive, flash drive, or any other physical medium. Physical medium may also be utilized to distribute the 3D anatomical data among several sub-networks. For example, the 3D anatomical data may be distributed to a sub-network or other collection of computing device stored on a physical medium. One of the networked devices or servers of the sub-network may store the 3D anatomical data and provide the 3D anatomical data to other networked devices via the sub-network.

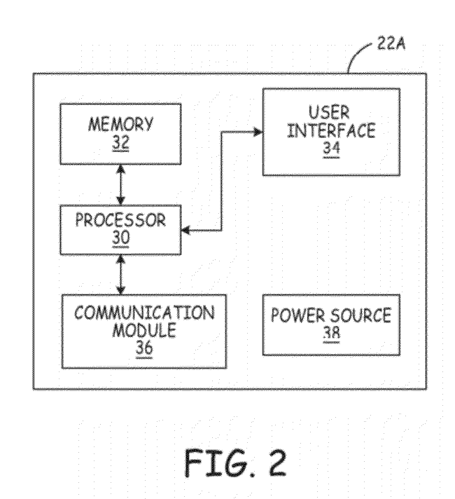

FIG. 2 is a functional block diagram illustrating an example configuration of user computing device 22A of FIG. 1. Although computing device 22A is described as an example, any of computing devices 22A-22N or other computing devices configured to provide the functions described may have similar characteristics. As shown in FIG. 2, computing device 22A may include a processor 30, memory 32, user interface 34, communication module 36, and power source 38. Computing device 22A may be an off-the-shelf user computing device, e.g., a commercially available computer workstation or notebook computer, running an application that enables computing device 22A to receive prepackaged anatomical data 21 via network 12 and present 3D anatomical representations of 3D models to the user. Alternatively, computing device 22A may be a dedicated hardware device with dedicated software for receiving prepackaged anatomical data 21 via network 12 and presenting the 3D anatomical representation.

A user may interact with computing device 22A via user interface 34, which may include a display to present 3D anatomical representations of the 3D models contained in the prepackaged anatomical data 21, present a menu with manipulation control and measurements tools, and device representations of medical devices. The display of user interface 34 may provide a graphical user interface to the user, and a keypad or another mechanism, e.g., a pointing device, for receiving input from a user. In other examples, user interface 34 may include a touchscreen interface, a 3D display, or any other input and output devices. Although user interface 34 may present information within a single screen, user interface 34 may be configurable to present various aspects of the presented information on different displays to optimize work area for the user. For example, user interface 34 may provide the 3D anatomical representation on one display and the menu and orientation reference image on another display.

When presenting a 3D anatomical representation, user interface 34 may receive a manipulation control input that manipulates the 3D anatomical representation. This manipulation control input may indicate how to rotate or move the 3D anatomical representation in the 3D environment displayed by user interface 34. In addition, the manipulation control input may increase or decrease the size of the 3D anatomical representation or even place the perspective of the user within a portion of the 3D model. The manipulation control input may also determine a portion of the 3D anatomical representation to remove to expose interior surfaces of the 3D model to the user. The manipulation control input may then adjust the angle and location of the exposed cross-sectional area of the 3D model. In this manner, the manipulation control input may allow expansive control over what portions of the 3D model is presented as the 3D anatomical representation.

Memory 32 may include any volatile, non-volatile, magnetic, optical, or electrical media, such as a random access memory (RAM), read-only memory (ROM), non-volatile RAM (NVRAM), electrically-erasable programmable ROM (EEPROM), flash memory, or any other digital or analog media. Memory 32 may store prepackaged anatomical data 21 received from server 14 via network 12 for use by processor 30 and user interface 34. In some examples processor 30 may unpack or otherwise generate data from prepackaged anatomical data 21 and store this new data in memory 32 to provide the various functions described herein.

In other examples, prepackaged anatomical data 21 may be received via network 12 in packets or segmented portions as needed to present the 3D anatomical representations or related metadata, for example. Memory 32 may store the portions of prepackaged anatomical data 21 as it is received from server 14. Allowing the user to begin work with the 3D models without all of prepackaged anatomical data 21 sent over network 12 may prevent delays caused by limitations in the data rate between sever 14 and computing device 22A. Alternatively, memory 32 may store data related to user interaction with prepackaged anatomical data 21 and temporarily store portions of prepackaged anatomical data 21. In this example, prepackaged anatomical data 21 may be streamed over network 12 such that computing device 22A retrieves portions of prepackaged anatomical data 21 from server 14 only as necessary to provide the user with requested functions and features.

Processor 30 may include any one or more of a microprocessor, a controller, a digital signal processor (DSP), an application specific integrated circuit (ASIC), a field-programmable gate array (FPGA), or equivalent discrete or analog logic circuitry. In some examples, processor 50 may include multiple components, such as any combination of one or more microprocessors, one or more controllers, one or more DSPs, one or more ASICs, or one or more FPGAs, as well as other discrete or integrated logic circuitry. The functions attributed to processor 50 herein may be embodied as software, firmware, hardware or any combination thereof.

Processor 30 may be configured or operable to perform any of the functions described herein. For example, processor 30 may instruct user interface 34 to present 3D anatomical representations according to prepackaged anatomical data 21 received from server 14 via network 12. Processor 30 may also interpret any input received by user interface 34, e.g., manipulation input or measure input, and perform the requested action of the input according to the instructions of prepackaged anatomical data 21. For example, in response to a manipulation input from the user to rotate the 3D anatomical representation about a specific axis, processor 30 may use the definitions of the 3D model within prepackaged anatomical data 21 to manipulate the 3D anatomical representation in accordance with the 3D model of the anatomical structure.

Processor 30 may also cut away selected portions of the 3D anatomical representation and calculate measurements requested by the user from one of the measurement tools provided in the menu. For example, processor 30 may calculate the distance between two user-selected points within the 3D anatomical representation according to the calibrated scale of the 3D model. In other examples, processor 30 may calculate cross-sectional areas, volumes, or angles between user-selected or pre-defined lines. In some examples, processor 30 may also color code each measurement visualized on the display and the corresponding numerical number. Processor 30 may also be configured to convert the units of each measurement to that requested by the user.

Communication module 36 may also be configured to communicate with a networked computing device (e.g., server 14) via wireless communication techniques, or direct communication through a wired connection to network 12. For example, communication module 36 may receive prepackaged anatomical data 21 from server 14. Prepackaged anatomical data 21 may include one or more pre-defined 3D models of one or more respective anatomical structures, and the pre-defined 3D models may be used by processor 30 to present the 3D anatomical representations. Direct wired connections may be used to provide faster data transfer rates between computing device 22A and server 14, and/or to provide a more secure connection over which prepackaged anatomical data 21 may be transmitted. Examples of local wireless communication techniques that may be employed to facilitate communication between computing device 22A and another networked computing device include RF communication according to the 802.11 or Bluetooth specification sets, infrared communication, e.g., according to the IrDA standard, or other standard or proprietary telemetry protocols. In some examples, computing device 22A may be capable of communicating with network 12 without needing to establish a secure wireless connection. However, communication module 36 may still establish a secure wireless connection with network 12 whenever required by network 12 or server 14.

In any case, communication module 36 may be configured to communicate with and exchange data between server 14 and/or other computing devices 22N. In some examples, communication module 36 may transmit an error report or operational log of the user's interaction with prepackaged anatomical data 21. The error report may include instances in which an error was detected with the presentation of the 3D anatomical representation or a user input could not be processed by processor 30 with prepackaged anatomical data 21. The operational log of the user interaction with prepackaged anatomical data 21 may include how the user manipulated, measured, or otherwise used the 3D anatomical representation and other data of prepackaged anatomical data 21. An administrator, e.g., a user with access to generate or modify the 3D models of prepackaged anatomical data 21, may review the error report and/or the operational log to identify problems with prepackaged anatomical data 21, update prepackaged anatomical data 21 to better suit the desires of the user, or even enhance features of prepackaged anatomical data 21 commonly utilized by the users.

Power source 38 may be a commercially available AC power supply, battery, or rechargeable battery, depending upon the type of computing device used as user computing device 22A. In some examples, computing device 22A may include two or more power sources that power one or more components. For example, a separate power source may provide operational power to user interface 34.

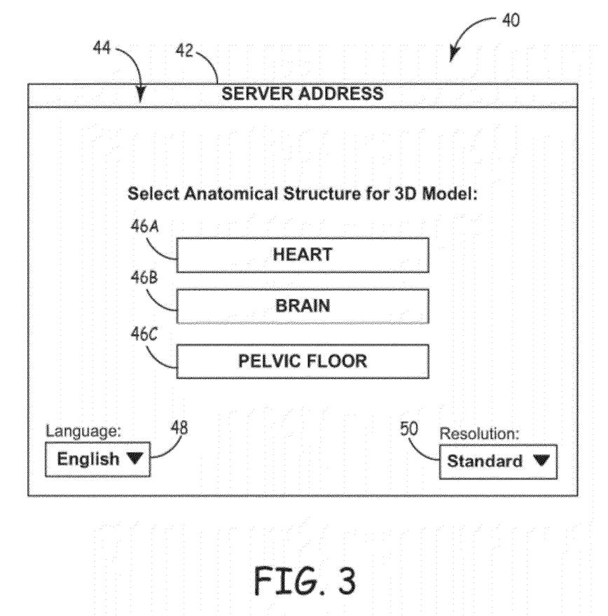

FIG. 3 is a conceptual drawing illustrating example user interface 40 for retrieving prepackaged anatomical data 21 from a networked computing device (e.g., server 14). User interface 40 may be similar to user interface 32 of user computing device 22A in FIG. 2. In this manner, user interface 40 may provide similar functionality and features attributed to user interface 32 or any other user interface described herein.

As shown in FIG. 3, user interface 40 provides screen 42. Screen 42 may include the information that is presented or displayed to the user with various shapes, colors, words, numbers, or other information related to the presentation of 3D anatomical representations. Specifically, screen 42 may be an introduction screen that is presented to the user upon initiation of the software program or module used to present 3D anatomical representations from prepackaged anatomical data 21. Screen 42 may include address bar 44 that indicates the network address of server 14 connected to computing device 22A.

Screen 42 also initiates the viewing environment for the user by specifying what type of anatomical structure the user wants to view. Screen 42 provides heart button 46A, brain button 46B, and pelvic floor button 46C (collectively “buttons 46”). By selecting one of buttons 46, the user selects a type of anatomical structure to initially view. For example, selecting heart button 46A may trigger computing device 22A to request prepackaged anatomical data 21 for the available 3D models of hearts. This prepackaged anatomical data 21 may include just one 3D model of a single heart or many 3D models of respective hearts with various healthy or diseased states. The initial request for the user to specify a type of anatomical structure with buttons 46 may limit the size of prepackaged anatomical data 21 needed to be distributed from server 14 to computing device 22A. However, at any time during the viewing session, the user may request a different type of anatomical structure and the related prepackaged anatomical data 21 may be received by computing device 22A.

Although buttons 46 only indicate a heart, brain, and pelvic floor, any other types of anatomical structures may be provided. For example, screen 42 may provide a selection for areas of the vasculature, kidneys, intestines, stomach, inner ear, bowel, knee joint, pelvis, lungs, bladder, reproductive organs, or any other anatomical structure for which there is an available 3D model in prepackaged anatomical data 21. Screen 42 may provide each anatomical structure as a separate button or as part of a drop-down menu, for example. Screen 42 may also provide a search field that allows the user to quickly input text to search for a specific type of anatomical structure. Alternatively, screen 42 may separate the anatomical structures according to any combination of healthy, diseased, or injured structures as appropriate for the user.

Although human anatomy is generally described herein, other examples of the prepackaged anatomical data 21 may include anatomical structures from one or more non-human organisms. For example, the user may select to view 3D models of various anatomical structures from pigs, dogs, cats, mice, rats, monkeys, fish, or any other animal. In this manner, data repository 20 may include 3D models for human and non-human specimens. This interspecies collection of 3D models may be useful for engineers or researches using animal models to investigate the efficacy of human therapy or determine what changes to make when progressing from an animal model to human studies.

Screen 42 may also allow the user to make additional selections. The user may use drop-down menu 48 to select the desired language, e.g., English, Spanish, or Japanese, of any instructions or metadata provided in the prepackaged anatomical data 21. Drop-down menu 50 may also allow the user to select the desired resolution of the presented 3D anatomical representation of the 3D models. If computing device 22A is utilizing a connection to network 12 with lower data transfer rates, the user may select lower resolution presentation from the prepackaged anatomical data 21. Server 14 may transmit prepackaged anatomical data 21 with lower resolution 3D models to limit the amount of data to distribute over network 12.

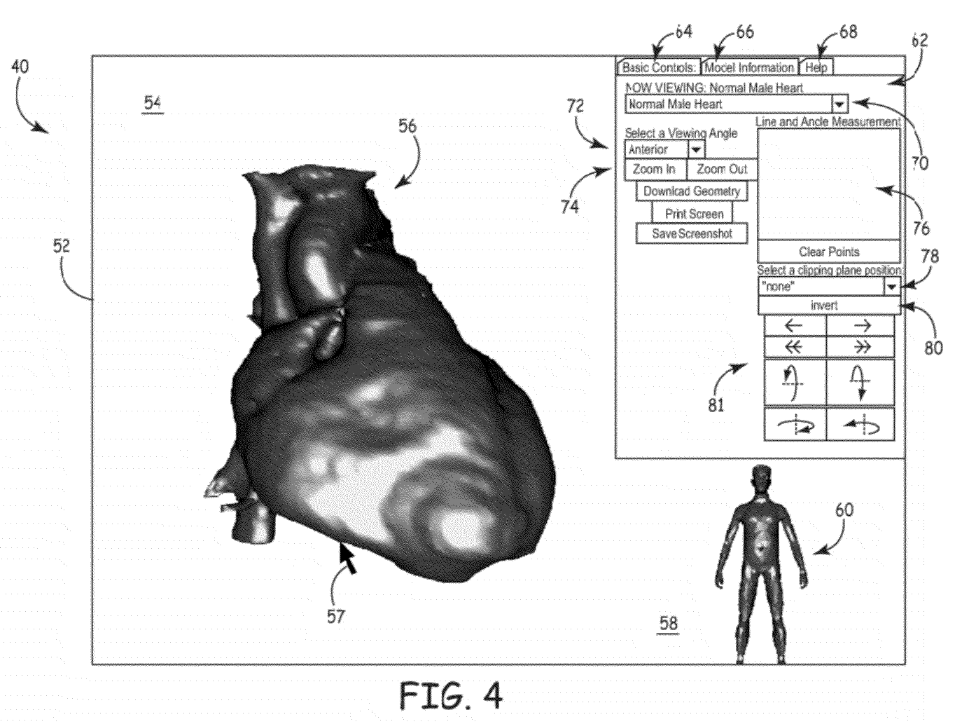

FIG. 4-19 are conceptual drawings illustrating example user interface 40 that presents 3D anatomical representations and provides various tools to interact with the 3D anatomical representations. User interface 40 will be generally described, and user interface 40 may be similar to user interface 32 of computing device 22A in FIG. 2. As shown in FIG. 4, user interface 40 may provide screen 52 as an initial presentation in response to the user selecting heart button 46A in screen 42 of FIG. 3, for example.

Screen 52 includes model area 54, orientation area 58, and menu 62. Model area 54 includes 3D anatomical representation 56 of the respective 3D model. The aspects of 3D anatomical representation 56 are controlled by the 3D model defined in prepackaged anatomical data 21 received via network 12 and server 14. Since the entire 3D model cannot be seen at any one time, the viewable portions of 3D model are described as 3D anatomical representation 56. 3D anatomical representation 56 may be manipulated and interacted with by the user within model area 54.

Screen 52 presents orientation reference image 60 within orientation area 58. Orientation reference image 60 indicates the presented orientation of 3D anatomical representation 56 in relation to the respective human body of orientation reference image 60. As 3D anatomical representation 56 is rotated, flipped, or otherwise moved within model area 54, orientation reference image 60 is moved accordingly. For example, if the user is being presented with the coronal view of orientation reference image 60, then the user is also being presented with the coronal view of 3D anatomical representation 56. Orientation reference image 60 provides an anchor or reference to what view of 3D anatomical representation 56 is being presented.

Menu 62 includes various information, controls, and tools that facilitate interaction with 3D anatomical representation 56. Menu 62 includes three tabs with distinct information. As shown in FIG. 4, tab 64 provides basic control of 3D anatomical representation 56 and what type of model is being viewed. Selection menu 70 receives a selection input from the user that selects one of the anatomical structures for which there is a 3D model available for viewing. As shown in FIG. 4, selection menu 70 indicates that the user is “NOW VIEWING: Normal Male Heart” as indicated by 3D anatomical representation 56. Once the user selects a particular anatomical structure, user interface 40 subsequently presents a portion of the respective 3D model as a new 3D anatomical representation. Selection menu 70 may be a drop-down menu, but other types of menus are contemplated to allow the user to select the desired anatomical structure.

Selection menu 70 may include variety of types of anatomical structures and a variety of healthy or disease states for each anatomical structure. For example, selection menu 70 may include a normal healthy adult heart, a healthy child heart, an enlarged heart due to heart failure, a heart subject to pulmonary hypertension, a heart subject to systemic hypertension, a heart subject to valve problems (e.g., mitral valve regurgitation), or any other problems that may affect the heart. These types of various healthy and diseased tissues may also be provided in 3D models of other anatomical structures throughout the body. In other examples, selection menu 70 may provide 3D models of anatomical structures that have sustained traumatic injury or other non-disease related problems.

Menu 62 may also provide various tools for manipulation control of 3D anatomical representation 56. Any of these tools to orient or otherwise change the view of 3D anatomical representation 56 may accept a manipulation control input that manipulates 3D anatomical representation 56. For example, view menu 72 may allow the user to select various views or angles of 3D anatomical representation 56, e.g., anterior, posterior, lateral, medial, dorsal, ventral, or any variety of specific oblique views. View menu 72 indicates that the “anterior” or front view of 3D anatomical representation 56 is currently provided. Zoom buttons 74 may also allow the user to manipulate 3D anatomical representation 56 may zooming in or zooming out from 3D anatomical representation 56.

In addition to the manipulation tools provided by menu 62, the user may use pointing device 57 to grab and rotate in any direction. In this manner, pointing device 57 may allow the user to orient 3D anatomical representation 56 to any view desired by the user. The user may manipulate 3D anatomical representation 56 up, down, left, right, or at any oblique angle. In some examples, the user may even specify an axis about which 3D anatomical representation 56 may be rotated.

Furthermore, menu 62 may include clipping plane menu 78, invert plane button 80, and plane movement buttons 81 to manipulate 3D anatomical representation 56. A clipping plane may be a plane that is “cuts” one part of 3D anatomical representation 56 from another part of 3D anatomical representation 56. In response to providing this clipping plane, only one side of the clipping plane is presented in model area 54. Clipping plane menu 78 may provide various different locations to insert a clipping plane within 3D anatomical representation 56. Example locations of available clipping planes in clipping plane menu 78 may include axial, coronal, or sagittal planes. Once the clipping plane is selected, the user may us invert plane button 80 to toggle between the portion of 3D anatomical representation 56 on either side of the clipping plane. The user may also move or rotate the clipping plane with plane movement buttons 81. Any of these techniques to rotate, move, or otherwise change the view of 3D anatomical representation 56 may be considered manipulation control.

Menu 62 may also include measurement field 76. Measurement field 76 may provide numerical values of measured aspects of 3D anatomical representation 56. For example, measurement field 76 may indicate a line distance, an angle between two lines, an area, or a volume of selected portions of 3D anatomical representation 56. The user may use pointing device 57 to select the portions of 3D anatomical representation 56 which the user desires to measure. The visualized measured portion of 3D anatomical representation 56 may be color matched to the numerical values provided in measurement field 76.

Although not shown in FIG. 4, menu 62 may also include specific measurement tools that the user may select to set the type of measurement and then use pointing device 57 to provide a measure input that defines the measured portion of 3D anatomical representation 56. Computing device 22A may then calculate the measured portion based on the measure input. User interface 40 may then present the visual identification (e.g., a line for the distance measurement) and a numerical calculation or value within measurement field 76.

Menu 62 also includes tabs 66 and 68. Tab 66 may provide various information about the 3D model used to present 3D anatomical representation 56 and/or metadata related to the patient from which the 3D model was generated. Tab 66 may also provide information about prepackaged anatomical data 21 transmitted from server 14 via network 12.

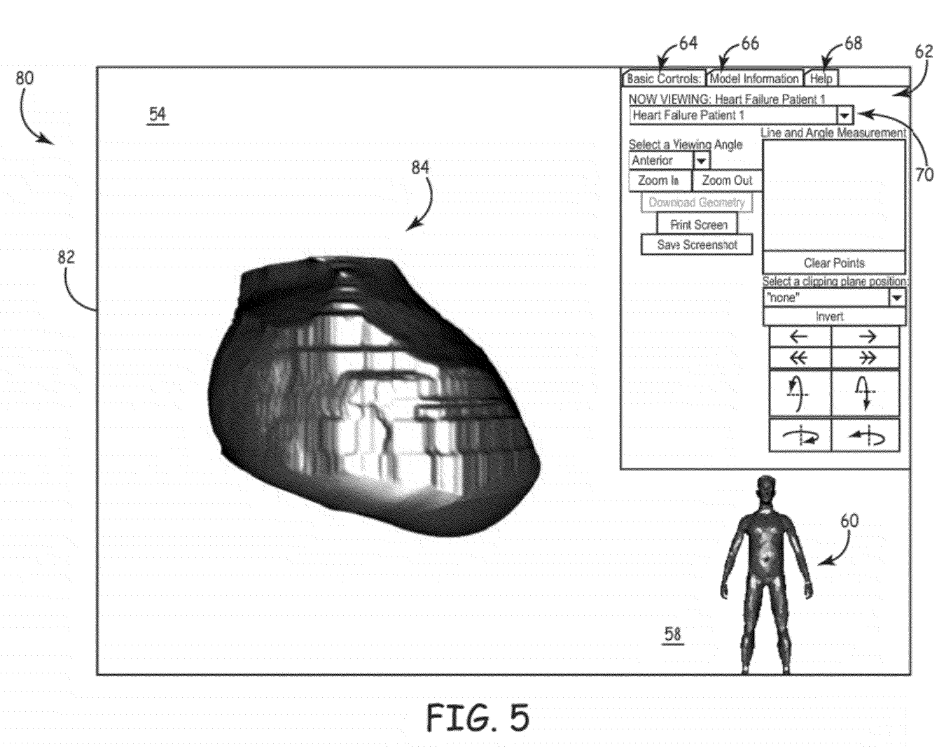

FIG. 5 illustrates example screen 82 of user interface 40. Screen 82 is similar to screen 42 of FIG. 4, but screen 82 indicates that the user has selected a different 3D model from selection menu 70. As shown in FIG. 5, selection menu 70 indicates that the user has selected a 3D model of a heart from a heart failure patient. The enlarged heart shown by 3D anatomical representation 84. When the user selects a new 3D model, such as the “Heart Failure Patient 1,” processor 30 of computing device 22A may retrieve the 3D model from the prepackaged anatomical information stored in memory 32. User interface 40 may then present a portion of the selected 3D model as 3D anatomical representation 84. Alternatively, computing device 22A may use communication module 36 to retrieve prepackaged anatomical data 21 from repository 20 and server 14 that includes the 3D model of the selected anatomical structure indicated by selection menu 70.

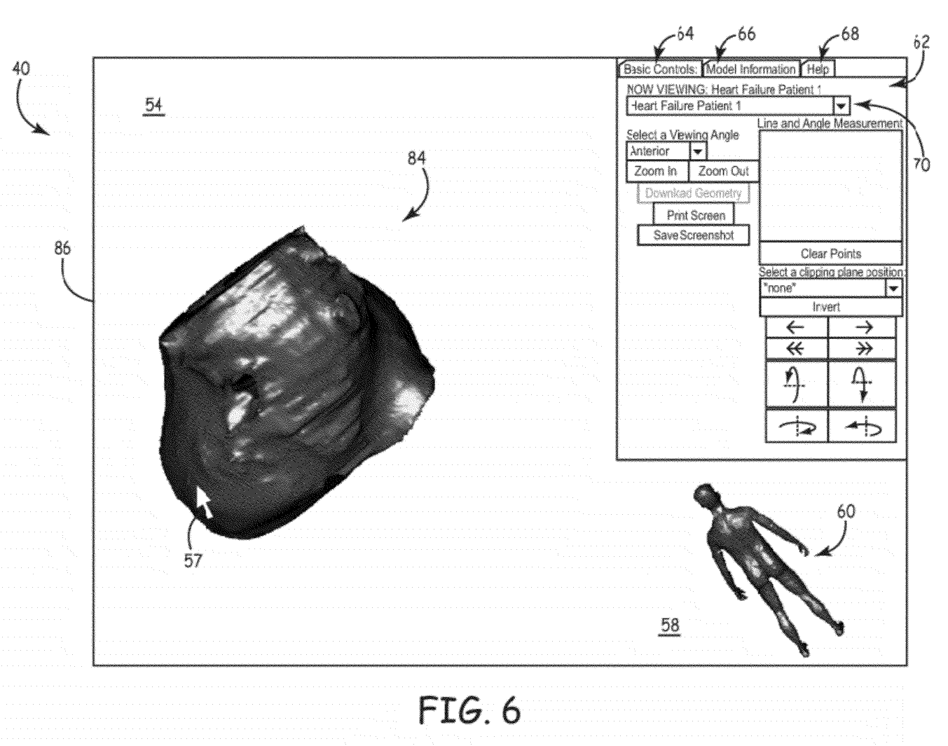

FIG. 6 illustrates example screen 86 of user interface 40. Screen 86 is similar to screen 82 of FIG. 5, but screen 86 presents 3D anatomical representation 84 rotated to a generally posterior view. The user may use pointing device 57 to click on and drag 3D anatomical representation 84 to freely rotate 3D anatomical representation 84 in any direction within the three dimensional space of model area 54. As 3D anatomical representation 84 is rotated, orientation reference image 60 may rotate in a similar manner to match the view of 3D anatomical representation 84 to the view of orientation reference image 60.

Orientation reference image 60 is shown as a human figure in the example of FIG. 6. However, orientation reference image 60 may be provided as a variety of different images. For example, orientation reference image 60 may be a cube with anatomical position terms (e.g., lateral, medial, dorsal, ventral, anterior, posterior) on each face of the cube indicating which direction 3D anatomical representation 84 is facing the user. In other example, orientation reference image 60 may be a 3D arrow that points up in the dorsal direction or the direction of a person's head. These and other types of orientation reference images may be presented by user interface 40.

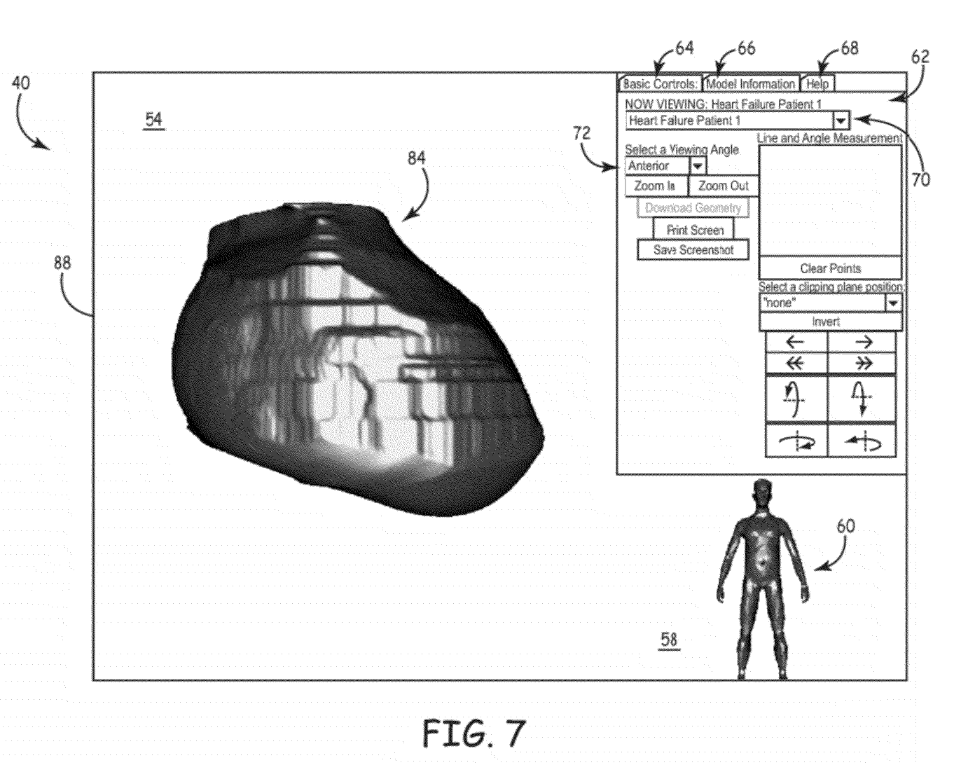

FIG. 7 illustrates example screen 88 of user interface 40. Screen 88 is similar to screen 82 of FIG. 5, but screen 88 presents a different view of 3D anatomical representation 84. In screen 88, the user has selected the “Anterior” view from view menu 72. When the view is selected from view menu 72, 3D anatomical representation 84 may be immediately reset to the selected view. Corresponding to the manipulated view of 3D anatomical representation 84, orientation reference image 60 may also be changed to the appropriate view.

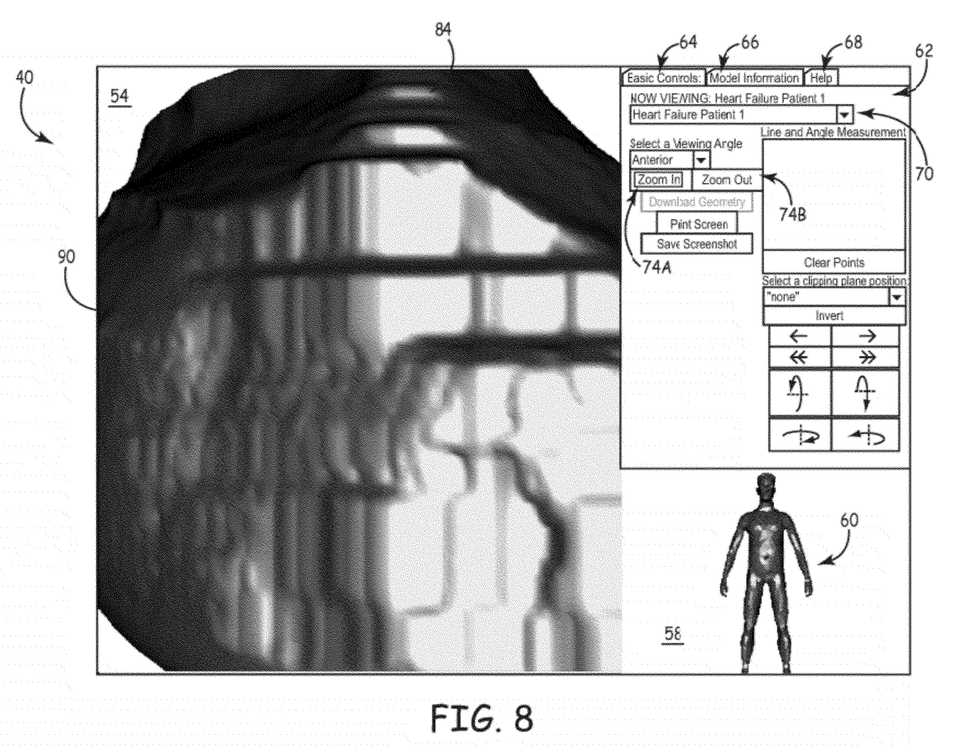

FIG. 8 illustrates example screen 90 of user interface 40. Screen 90 is similar to screen 88 of FIG. 7, but screen 90 includes a zoomed in view of 3D anatomical representation 84. Menu 62 includes zoom-in button 74A and zoom-out button 74B (collectively “zoom buttons 74”). When the user selects zoom-in button 74A, 3D anatomical representation 84 will increase in size with respect to model area 54. When the user selects zoom-out button 74B, 3D anatomical representation 84 will decrease in size with respect to model area 54. As with screen 90 or any other screen described herein, a scale may be provided to indicate the actual size of 3D anatomical representation 84 in any units selected by the user, e.g., centimeters or inches).

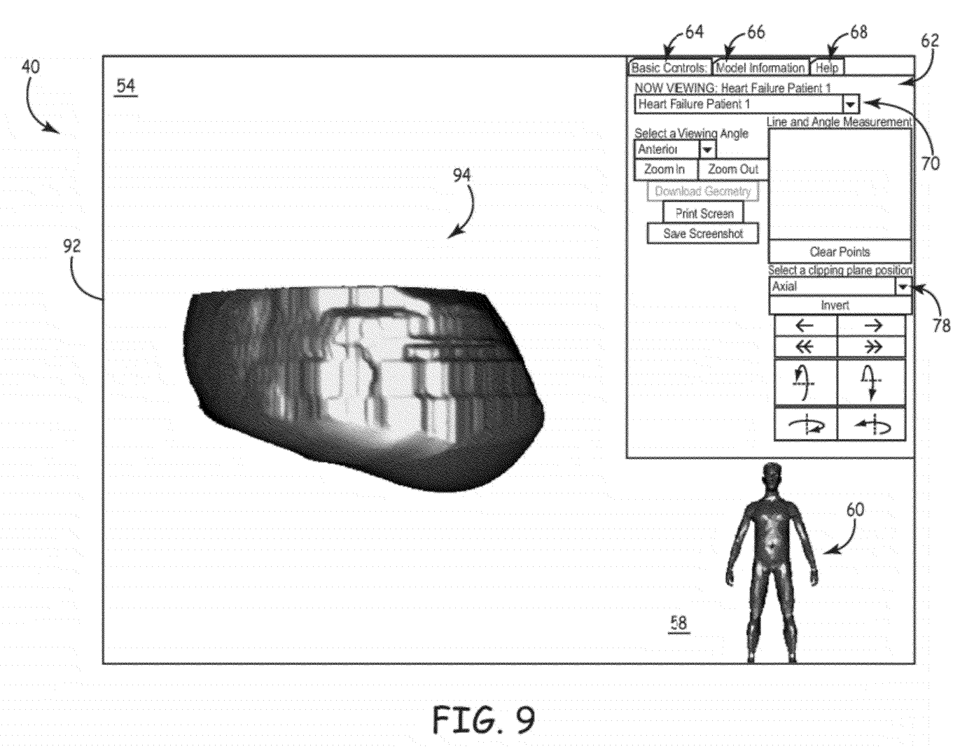

FIG. 9 illustrates example screen 92 of user interface 40. Screen 92 is similar to screen 88 of FIG. 7, but screen 92 illustrates 3D anatomical representation 94 that has been manipulated from 3D anatomical representation 84 with a clipping plane. As shown in the example of FIG. 9, the user has selected the “axial” clipping plane from clipping plane menu 78. The axial clipping plane has been applied to 3D anatomical representation 94 to only show a portion of the 3D model on one side of the selected clipping plane. In other examples, the user may select a coronal clipping plane or sagittal clipping plane.

When the user selects a clipping plane from clipping plane menu 78, the selected clipping plane may be initially positioned at a middle position of the 3D anatomical representation. In this manner, the user may apply the clipping plane to the 3D anatomical representation. The clipping plane removes a portion of the 3D anatomical representation on one side of the clipping plane. Therefore, the clipping plane exposes a cross-section of the 3D anatomical representation. Once the clipping plane is selected, the user may move the clipping plane as further described herein. In other examples, menu 62 may provide various clipping plane icons that the user may select and place at the desired location of 3D anatomical representation 94. The clipping plane may allow the user to “open up” or view internal surfaces of the selected 3D model.

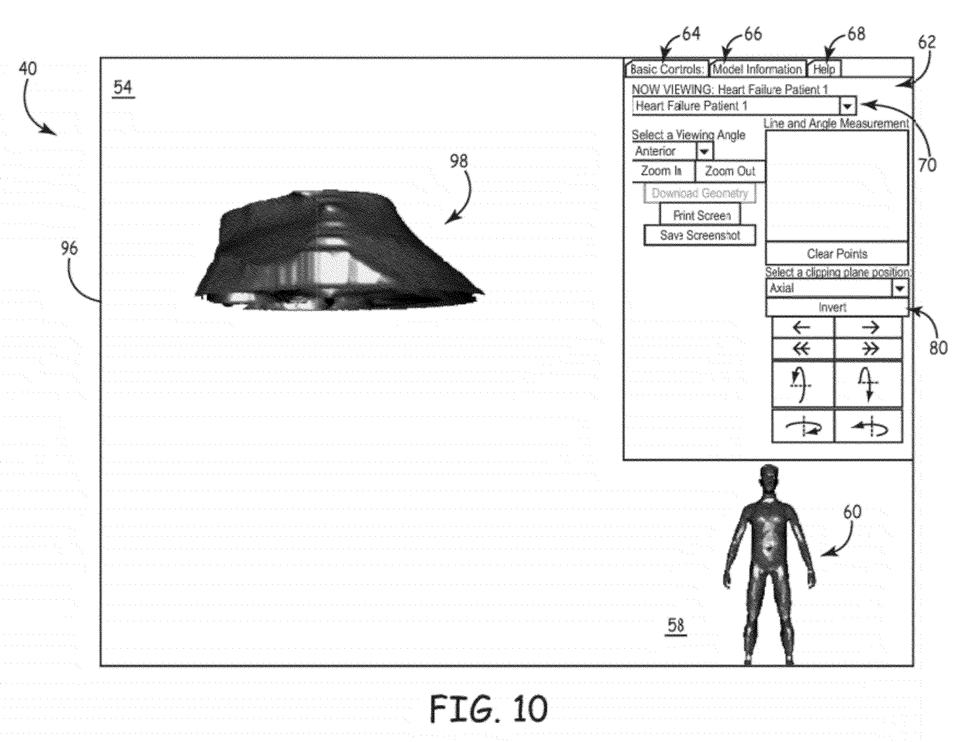

FIG. 10 illustrates example screen 96 of user interface 40. Screen 96 is similar to screen 92 of FIG. 9, but screen 96 illustrates 3D anatomical representation 98 that has been manipulated or inverted about the clipping plane used to create 3D anatomical representation 94 of FIG. 9. The user may invert or flip the presented portion of the 3D anatomical representation about the provided clipping plane. The user may provide this invert input by selecting invert button 80 provided in menu 62. The user may rotate or otherwise further manipulate 3D anatomical representation 98 in any manner described herein. In some examples, the user may be able to apply two or more clipping planes to the 3D anatomical representation presented in model area 54. Multiple clipping planes, either parallel or orthogonal planes, may allow the user to view how interior surfaces meet each other and expose complex structures.

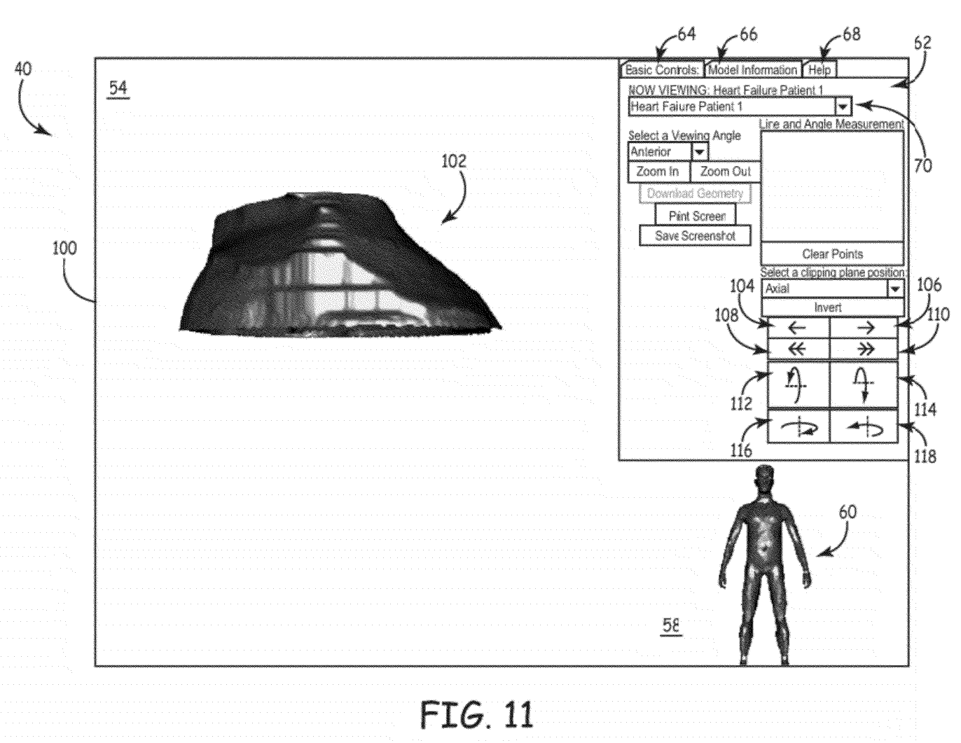

FIG. 11 illustrates example screen 100 of user interface 40. Screen 100 is similar to screen 96 of FIG. 10, but screen 100 illustrates 3D anatomical representation 102 in which the axial clipping plane has been moved in the interior direction from 3D anatomical representation 98 of FIG. 10. The user may have selected large translation button 110 to translate the clipping plane a relatively large distance along the axial direction of the 3D model to move from 3D anatomical representation 98 to 3D anatomical representation 102.

Menu 62 may provide a variety of different inputs to manipulate the position of the clipping plane and the portion of the 3D model indicated by 3D anatomical representation 102. Menu 62 may provide small distance arrows 104 and 106 that each move the clipping plane a relatively small distance in opposing directions. For example, this relatively small distance may be one pixel, the smallest resolution of the 3D model, or a specified distance (e.g., one millimeter or a tenth of an inch). Menu 62 may also provide large distance arrows 108 and 110 that each move the clipping plane a relatively large distance in opposing directions. For example, this relatively large distance may be ten pixels, 10 millimeters, or one inch. In other examples, the user may select the magnitude of movement in the clipping plane for each of small distance arrows 104 and 106 and large distance arrows 108 and 110.

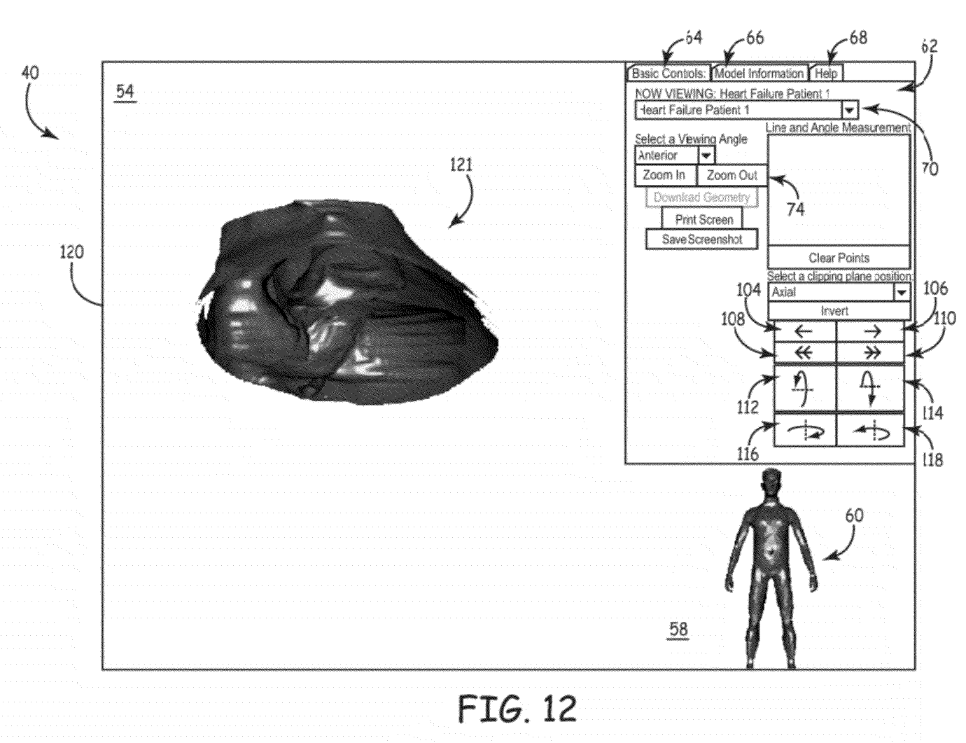

FIG. 12 illustrates example screen 120 of user interface 40. Screen 120 is similar to screen 100 of FIG. 11, but screen 120 illustrates 3D anatomical representation 121 in which the clipping plane has been rotated from that of FIG. 11. The user may select plane rotation button 116 to manipulate 3D anatomical representation 102 to 3D anatomical representation 121. Plane rotation buttons 116 and 118 may rotate the provided clipping plane in opposite directions about a line in the coronal plane. Plane rotation buttons 112 and 114 may rotate the provided clipping plane in opposite directions about a line in the sagittal plane. The solid surfaces of 3D anatomical representation 121 that are being clipped by the clipping plane may be shown in a different color or texture to indicate the presented cross-sectional area exposed by the clipping plane.

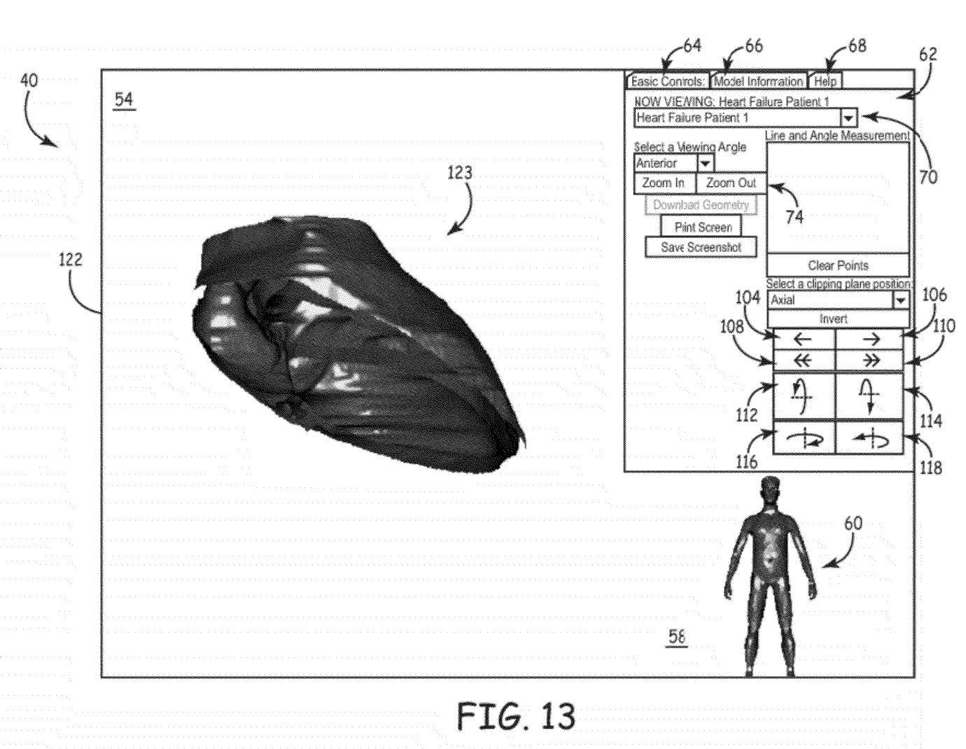

FIG. 13 illustrates example screen 122 of user interface 40. Screen 122 is similar to screen 100 of FIG. 11, but screen 122 illustrates 3D anatomical representation 123 in which the clipping plane has been rotated from that of FIG. 11. The user may select plane rotation button 114 to manipulate 3D anatomical representation 102 to 3D anatomical representation 123. In this manner, plane rotations buttons 112, 114, 116, and 118 may rotation the position of the clipping plane to allow the user to view various internal structures of the selected 3D model. In other examples, user interface 40 may provide the clipping plane with handles, for example, that allow the user to grab the clipping plane with a pointing device and move the clipping plane to the desired location. This free rotation of the clipping plane may be available in addition to other buttons, e.g., plane rotation buttons 112, 114, 116, and 118, with pre-defined movements for the clipping plane.

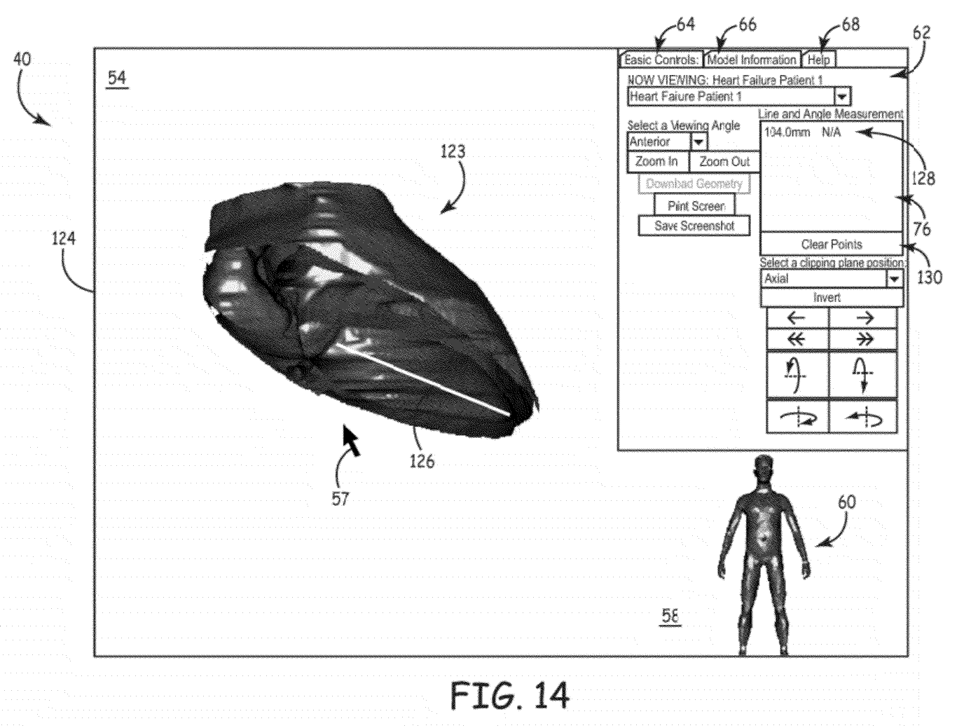

FIG. 14 illustrates example screen 124 of user interface 40. Screen 124 is similar to screen 122 of FIG. 13, but screen 124 illustrates 3D anatomical representation 123 with a measurement line 126. The user may use pointing device 57 to define the endpoints of a line and measure the distance of the line according to the scale of 3D anatomical representation 123. The user selected points may be automatically locked to a position of the anatomical structure represented on the display. Once measurement 126 is defined, computing device 22A may calculate and display the numerical value of the distance as measurement value 128 in measurement field 76. As shown in FIG. 14, processor 30 has calculated measurement line 126 between a point on the mitral valve annulus to the left ventricular apex to be “104.0 mm” as indicated by measurement value 128. This measurement 126 is thus a distance between two points of the actual anatomy (i.e., the anatomical structure of the patient) modeled and presented as a portion of the 3D model. In addition, measurement line 126 may be visualized in a color that matches measurement value 128 presented in measurement field 76. As the user defines additional measurement lines in model area 54, each measurement line may be visualized with 3D anatomical representation 123 in a color that matches the respective measurement value presented in measurement field 76. If the user does not want to view the measurements, the user can select clear button 130 to clear the measurement lines and corresponding measurement values.

Measuring other aspects of 3D anatomical representation 123 may be performed in a similar manner. The user may use pointing device 57 to define the measured portion and then processor 30 of computing device 22A may calculate the value of the measured portion. This technique may be provided for any types of measurements, e.g., linear distances, angles, cross-sectional areas, or even volumes of defined portions. In some examples, menu 62 may provide a distance tool, an area tool, a volume tool, or an angle tool so that the user would select the desired tool and then use that selected tool to define the measured portion.

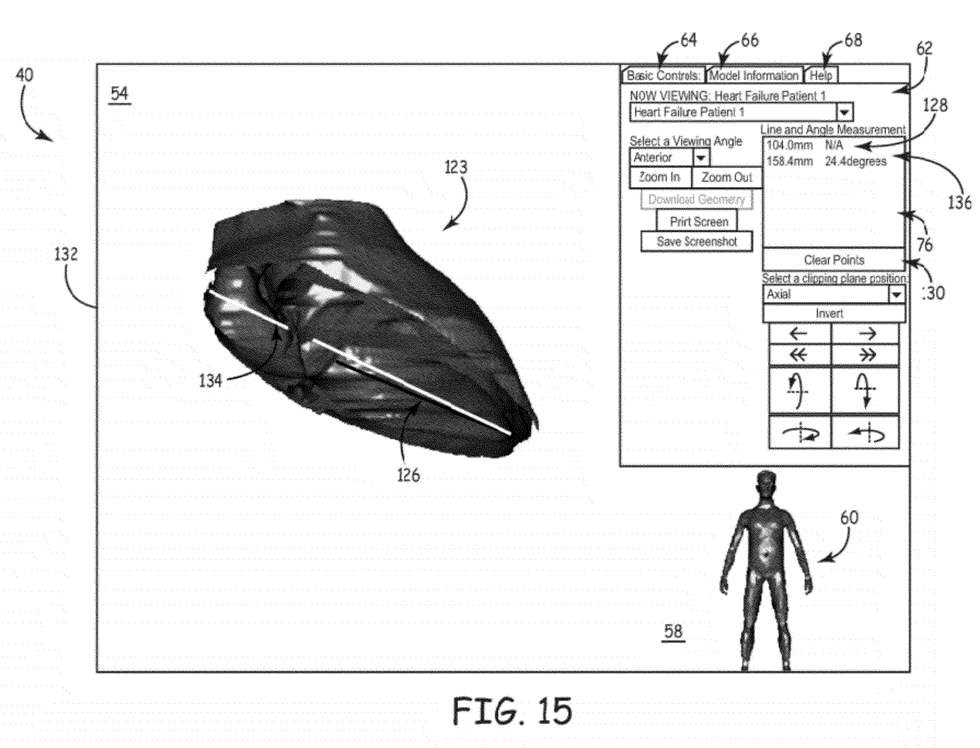

FIG. 15 illustrates example screen 132 of user interface 40. Screen 132 is similar to screen 124 of FIG. 14, but screen 132 illustrates 3D anatomical representation 123 with measurement line 126 and measurement line 134. The user has added measurement line 134 by defining the two endpoints, and the resulting numerical value for the distance of measurement line 134 is indicated by measurement value 136. Measurement value 136 is also presented in the same matching color as measurement line 134. In the example of FIG. 15, measurement value 136 indicates that measurement line 134 has a distance of “158.4 mm.” Furthermore, processor 30 has calculated an angle between measurement lines 126 and 134 because the lines share a common endpoint at the apex of the left ventricle. Measurement value 136 also indicates this angle as “24.4 degrees,” as an example. If the user were to define a third line that shared an endpoint with measurement line 134, for example, a second angle between those lines may be calculated and presented in measurement field 76.

In some examples, cross-sectional areas or volumes of defined measured portions may also be available to the user. These areas or volumes may also be provided in measurement field 76 with any previously calculated distances. In other examples, the user may select to only view one or more of the measured portions. The user may toggle between which measured portions are presented with 3D anatomical representation 123 by clicking on the measured values in measurement field 76, for example. In addition, or alternatively, menu 62 may provide pre-calculated distances, areas, or volumes of common structures of the selected 3D model. These pre-calculated measurements may be selected by the user to also visualize the measured portion along with 3D anatomical representation 123. For example, pre-calculated volumes of the atria and ventricles may be provided for a 3D model of the heart.

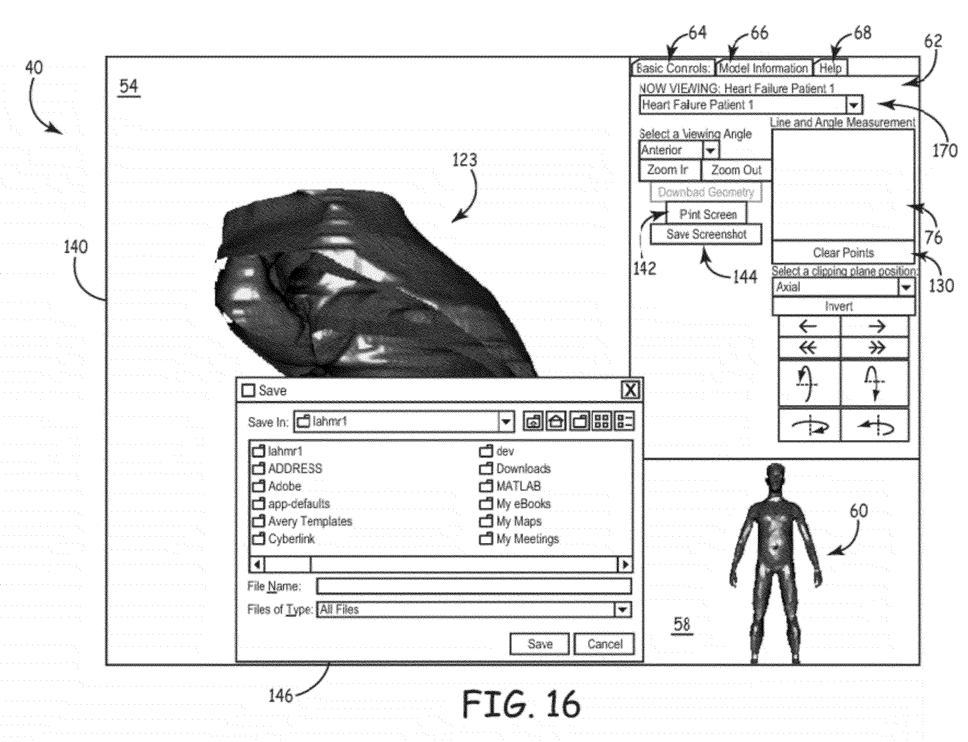

FIG. 16 illustrates example screen 140 of user interface 40. Screen 140 is similar to screen 132 of FIG. 15, but screen 140 illustrates dialog box 146. As shown in FIG. 16, the user may select print screen 142 or save button 144 to store a copy of 3D anatomical representation 123 and/or other areas of user interface 40. When the user selects save button 144, dialog box 146 may pop-up to allow the user to save a screenshot of the workspace of screen 140 (except for dialog box 146). The user may enter a name for the screenshot and then save the screenshot in memory 32. The screenshot may store a copy of 3D anatomical representation 123, orientation reference image 60, and menu 62. The screenshot may store anything presented on the screen, e.g., measurement values and measured portions. Alternatively, the user may select print screen 142 to copy an image of screen 140 to be pasted into another document or software environment.

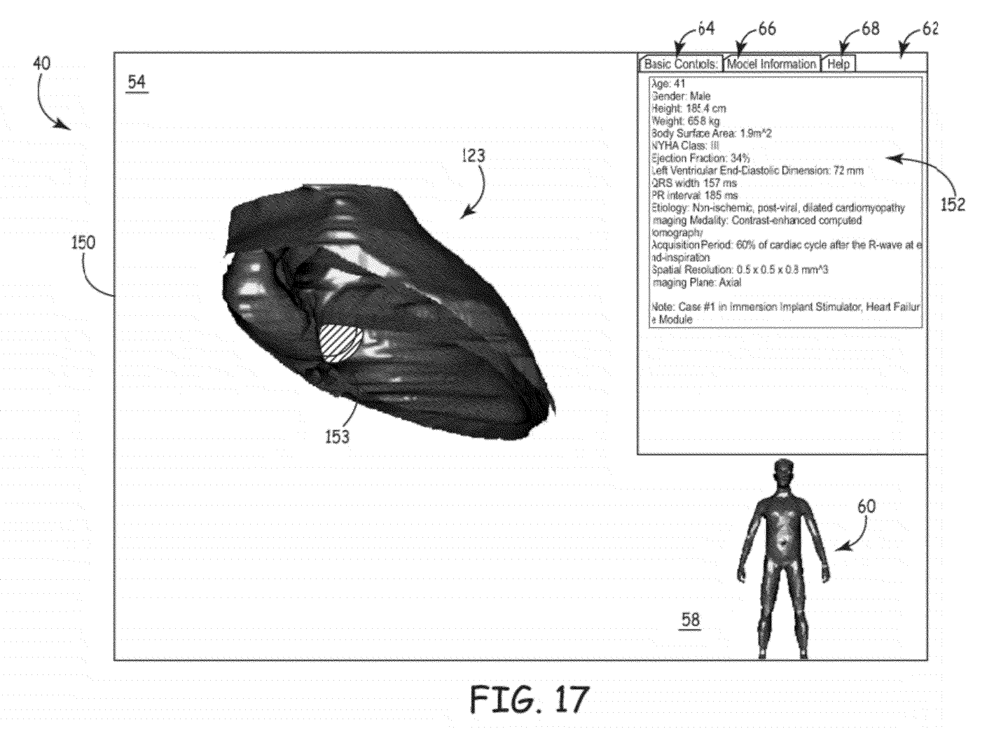

FIG. 17 illustrates example screen 150 of user interface 40. Screen 150 is similar to screen 122 of FIG. 13, but screen 150 illustrates device representation 153 and tab 66 that includes metadata. As shown in FIG. 17, the user has selected tab 66 to access metadata 152 related to the 3D model used to create 3D anatomical representation 123. Metadata 152 may be related to the anatomical structure and patient on which the presented 3D model is based. Metadata 152 may include information such as a height, a weight, a gender, an age, and health status of the patient. In addition, metadata 152 may include diagnostic information related to the anatomical structure, received treatments, or any other related information. Metadata 152 may also include technical information such as the imaging parameters used to image the patient associated with the respective anatomical structure of the 3D model.

The user may also request additional information regarding the 3D model used to create 3D anatomical representation 123. The user may select tab 68 to access a help menu or dialog session with an administrator. The user may send an e-mail, send an instant message, or even request a phone call from an administrator to ask questions concerning the 3D model, the patient, or any other related information. The administrator may be able to respond directly within the tab so that the user does not need to exit from user interface 40.

In addition to presenting 3D anatomical representation 123, the user may desire to view how device representation 153 would be located in relation to 3D anatomical representation 123. Device representation 153 may be a portion of a 3D model of a medical device selected by the user. For example, the user may select the medical device from menu 62 or import the medical device from a different software program. In turn, user interface 40 may present the 3D model of the selected medical device. The user may then position the 3D model within 3D anatomical representation 123 to model the fit between the 3D model and the 3D anatomical representation. The user may still freely rotate 3D anatomical representation 123 and device representation 153 locked together. In the example of FIG. 17, device representation 153 may be a 3D model of an artificial mitral valve.

In some examples, user interface 40 may receive a device modification input that modifies one or more characteristics of the selected medical device. For example, the user may redefine one or more dimensions of the 3D model, remove a portion of the 3D model, or add additional features to the 3D model. In this manner, user interface 40 may promote the design of medical devices with the aid of 3D anatomical representation 123 as a virtual boundary on appropriate dimensions. Once the device modification input is received by user interface 40, processor 30 may update the 3D model of the medical device based on the device modification input. User interface 40 may then present the updated device representation. To facilitate the device modification input, menu 62 may present device modification tools.

In other examples, user interface 40 may communicate with other 3D drafting software packages and incorporate models created within another software package with 3D anatomical representation 123. For example, user interface 40 may create a link to the medical device 3D model in the outside software package. In this manner, the user may continue to modify or edit the 3D model using the other drafting software but while viewing 3D anatomical representation 123 within user interface 40. Example 3D drafting software packages may be AutoCAD, ProEngineer, SolidWorks, or other commercially available packages.

The 3D model that defines 3D anatomical representation 123 may, in some examples, be used as boundaries for device representation 153. As the user modifies device representation 153, user interface 40 may not allow certain dimensions or features that would interfere with tissue indicated by 3D anatomical representation 123. In this manner, the user may get direct feedback as to what dimensions may be appropriate for a product. User interface 40 may thus help to drive design progress and feature selection.

Although user interface 40 may generally present stationary or static 3D models, dynamic motion of the 3D models may be provided in other examples. For example, user interface 40 may present heart wall motion that corresponds to the cardiac depolarization and repolarization cycle. Device representation 153 may also be provided with the dynamic motion to visualize possible physiological issues with the medical device with the anatomical structure.

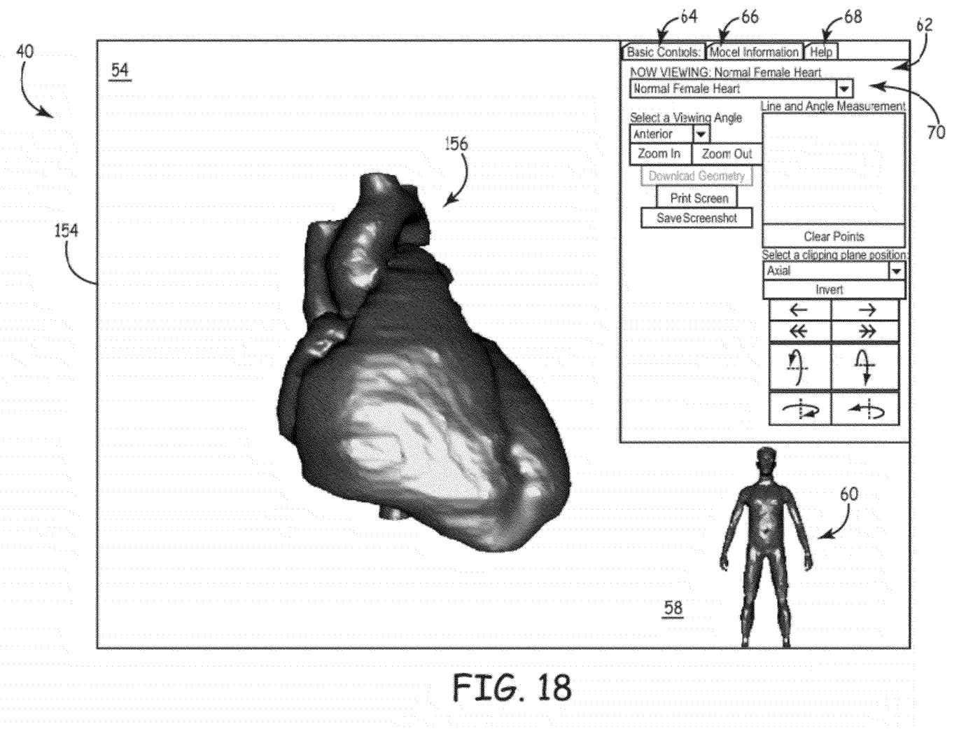

FIG. 18 illustrates example screen 154 of user interface 40. Screen 154 is similar to screen 82 of FIG. 5, but screen 154 presents 3D anatomical representation 156 of a different anatomical structure. 3D anatomical representation 156 may be a portion of the 3D model for a “normal female heart” selected from selection menu 70. At any time, the user may use selection menu 70 to select the desired 3D model for viewing. In some examples, user interface 154 may provide a pop-up window that requests the user to confirm the selection of a new 3D model to avoid unintentional loss of working data.

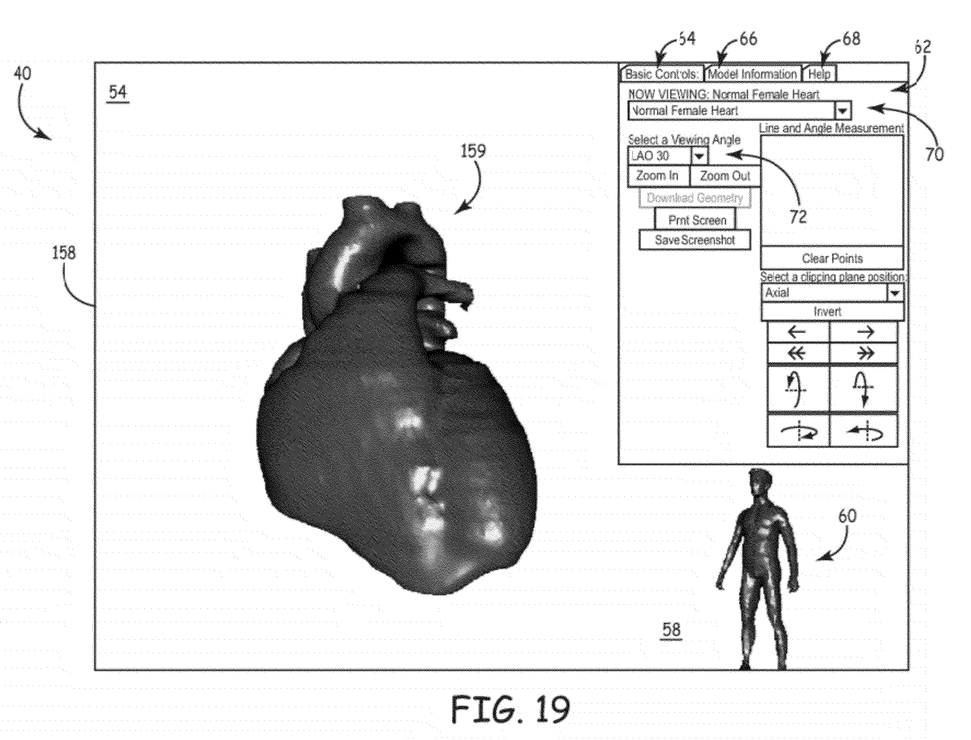

FIG. 19 illustrates example screen 158 of user interface 40. Screen 158 is similar to screen 154 of FIG. 18, but screen 158 presents 3D anatomical representation 159 of a different view of the 3D model. As shown in FIG. 19, the user may use view menu 72 to select the desired view of the 3D model. Selection of the left anterior oblique (“LAO”) view may then cause user interface 40 to present 3D anatomical representation 159. Orientation reference image 60 may rotate accordingly to indicate the position of 3D anatomical representation 159 within a human.

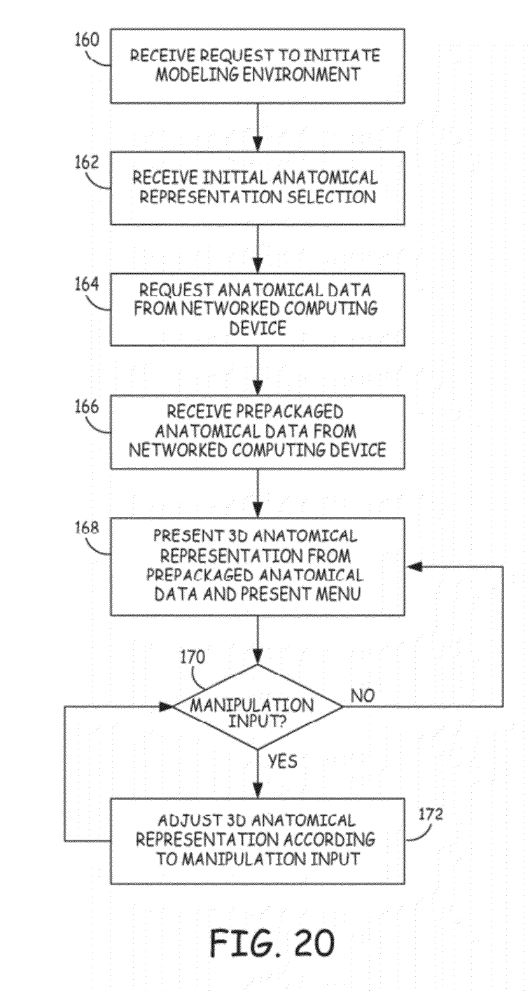

FIG. 20 is a flow diagram of an example technique for presenting and manipulating a 3D anatomical representation from prepackaged anatomical data 21. User interface 40 and system 10 will be used to describe the technique of FIG. 20, but any other user interface, user computing device, or networked computing device may be used in other examples. User computing device 22A may initially receive a request from the user to initiate the modeling environment of user interface 40 (160). User computing device 22A may then receive an initial anatomical structure selection that defines a 3D model for presentation (162).

Upon receiving the anatomical structure selection, computing device 22A may request prepackaged anatomical data 21 from a networked computing device such as sever 14 (164). In other examples, prepackaged anatomical data 21 may be requested immediately upon initiation of the modeling environment if prepackaged anatomical data 21 includes all 3D models of the available anatomical structures. After the request, communication module 36 of user computing device 22A may receive the distributed prepackaged anatomical data 21 from server 14 via network 12 (166).

Processor 30 may then instruct user interface 40 to present 3D anatomical representation 56, for example, based on the 3D model defined by prepackaged anatomical data 21 (168). User interface 40 may also present menu 62 to provide manipulation control and measurement tools to the user. If user interface 40 does not receive a manipulation input from the user (“NO” branch of block 170), user interface 40 continues to present 3D anatomical representation 56. If user interface 40 receives a manipulation input from the user (“YES” branch of block 170), then user interface 40 adjusts 3D anatomical representation 56 according to the manipulation input provided by the user (172). User interface 40 may then wait for additional manipulation input (170).

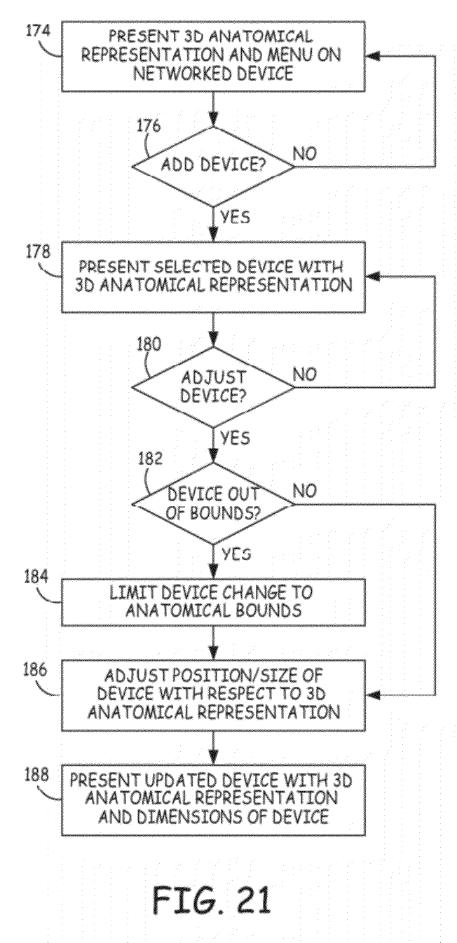

FIG. 21 is a flow diagram of an example technique for presenting a device representation of a medical device within the 3D anatomical representation. User interface 40, device representation 153, and 3D anatomical representation 123 may be used to describe the technique of FIG. 21. However, representations of medical devices or other devices may be provided with any other user interfaces or 3D anatomical representations.

User interface 40 may initially present 3D anatomical representation 123 and menu 62 on networked user computing device 22A (174). If the user does not want to add a model of a medical device to 3D anatomical representation 123 (“NO” branch of block 176), user interface 40 may continue to present 3D anatomical representation 123 (174). If the user selects a model of a medical device to add to 3D anatomical representation 123 (“YES” branch of block 176), user interface 40 may present device representation 153 of the 3D model of the selected device with 3D anatomical representation 123.

If user interface 40 receives user input to adjust device representation 153 (“YES” branch of block 180), user interface 40 may check to see if the input requests adjustment or modification that would put the device 3D model out of bounds (182). An adjusted device 3D model would be out of bounds if any portion of the device would occupy the same virtual space as any portion of the anatomical 3D model presented by user interface 40. In other words, user interface 40 may check for errors that may arise due to any new modification of the device 3D model. If the adjustment would put the device 3D model out of bounds (“YES” branch of block 182), processor 30 may limit the requested change to the device 3D model to the boundaries presented by the anatomical model (184).

If the adjusted device 3D model is within bounds (“NO” branch of block 182), processor 30 may adjust the position and/or size of the device 3D model with respect to the 3D anatomical representation (186). User interface 40 may then present the updated device representation with 3D anatomical representation 123 and new dimensions of the updated device representation. In this manner, user computing device 22A may aid the user to ensure that device 3D models remain within the anatomical limits imposed by the user. In some examples, user interface 40 may output the characteristics of the device 3D model to external software packages or other users to facilitate the design process.

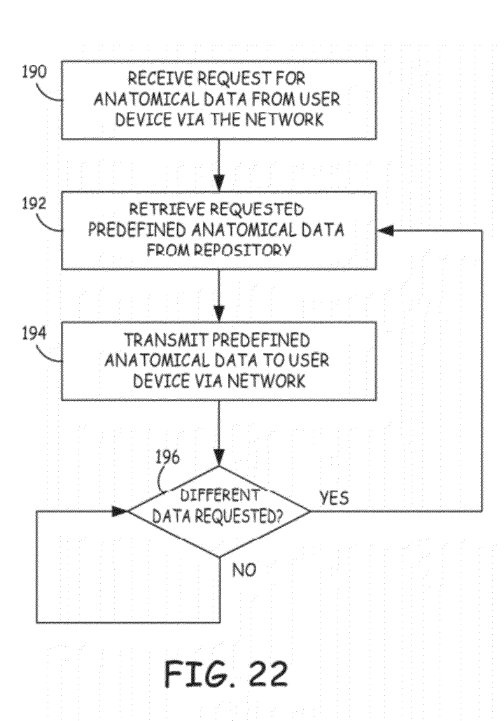

FIG. 22 is a flow diagram of an example technique for transmitting prepackaged anatomical data 21 to user computing device 22A via network 12. Before 3D anatomical representations can be presented to a user on computing device 22A, the underlying prepackaged anatomical data 21 must be distributed to computing device 22A via network 12. As shown in FIG. 22, server 14 may only transmit a requested portion of prepackaged anatomical data 21 based on the anatomical structure indicated by the user. Although computing device 22A is used as an example, any other user computing device 22N may provided instead.

The example technique of FIG. 22 begins when server 14, a networked computing device, receives a request for prepackaged anatomical data from user computing device 22A via network 12 (190). This request may specify one or more anatomical structures of interest to the user or a particular 3D model. By only sending a portion of the entire library of prepackaged anatomical data, transmission time of the distributed prepackaged anatomical data may be reduced. Server 14 may then retrieve the requested predefined anatomical data 21 from repository 20 (192) and transmit the predefined anatomical data to user computing device 22A via network 12 (194). If the user requests different prepackaged anatomical data for different anatomical structures or 3D models (“YES” branch of block 196), server 14 may retrieve the newly requested portion of prepackaged anatomical data 21 (192) and transmit the newly retrieved prepackaged anatomical data (194).

The techniques described herein may allow networked users access to 3D models of anatomical structures. A networked user device may retrieve prepackaged anatomical data 21 from a network server, for example, via a network. The user device may present 3D anatomical representations of the 3D models included in prepackaged anatomical data 21 without needing to generate 3D models from raw imaging data. The user device may also allow the user to take measurements of the 3D anatomical representations, manipulate the 3D anatomical representations, and present 3D models of devices within the 3D anatomical representations. In this manner, the user may interact with complex 3D models over a network without having the knowledge necessary to generate 3D models from imaging data, for example.

Various examples have been described. These and other examples are within the scope of the following claims.

1. A method comprising:
receiving prepackaged anatomical data, wherein the prepackaged anatomical data comprises one or more pre-defined three-dimensional (3D) models of one or more respective anatomical structures;
presenting at least a portion of the one or more 3D models as a 3D anatomical representation;
presenting a menu with the 3D anatomical representation, wherein the menu comprises manipulation control of the 3D anatomical representation and measurement tools;
receiving a manipulation control input; and
manipulating the 3D anatomical representation according to the manipulation control input.

2. The method of claim 1, wherein receiving prepackaged anatomical data comprises receiving prepackaged anatomical data from a networked computing device via a network.

3. The method of claim 1, presenting an orientation reference image comprising a human body adjacent to the 3D anatomical representation, wherein the orientation reference indicates an orientation of the human body that corresponds to a presented orientation of the 3D anatomical representation.

4. The method of claim 1, further comprising:
receiving a selection input from a user that selects one of the one or more anatomical structures; and
subsequently presenting a portion of the 3D model of the selected anatomical structure as the 3D anatomical representation.

5. The method of claim 4, wherein the one or more anatomical structures comprise one or more healthy anatomical structure and one or more diseased anatomical structure.

6. The method of claim 1, wherein the measurement tools of the menu comprise at least one of a distance tool, an area tool, a volume tool, or an angle tool, the method further comprising:
receiving a measure input that defines a measured portion of the 3D anatomical representation using one of the distance tool, the area tool, the volume tool, or the angle tool;
calculating a measurement of the measured portion based on the measure input; and
presenting a visual identification of the measured portion of the 3D anatomical representation and a numerical calculation of the measurement.

7. The method of claim 1, further comprising presenting a device representation in relation to the 3D anatomical representation, wherein the device representation is at least a portion of a 3D model of a medical device selected by a user.

8. The method of claim 7, further comprising:
receiving device modification input that modifies one or more characteristics of the selected medical device;
updating the 3D model based on the device modification input; and
presenting an updated device representation.

9. The method of claim 1, further comprising presenting metadata related to the respective anatomical structure on which the presented 3D model is based, wherein the metadata comprises at least one of a height, a weight, a gender, an age, a health status, or imaging parameters associated with a patient associated with the respective anatomical structure.

10. The method of claim 1, wherein receiving the manipulation control input comprises receiving an input defining a clipping plane, and wherein manipulating the 3D anatomical representation comprises applying the clipping plane to the 3D anatomical representation to expose a cross-section of the 3D anatomical representation.

11. A device comprising:
a processor configured to receive prepackaged anatomical data, wherein the prepackaged anatomical data comprises one or more pre-defined three-dimensional (3D) models of one or more respective anatomical structures; and
a user interface configured to:
present at least a portion of the one or more 3D models as a 3D anatomical representation;
present a menu with the 3D anatomical representation, wherein the menu comprises manipulation control of the 3D anatomical representation and measurement tools;
receive a manipulation control input; and
manipulate the 3D anatomical representation according to the manipulation control input.

12. The device of claim 10, further comprising a communication module configured to receive the prepackaged anatomical data from a networked computing device via a network.

13. The device of claim 11, wherein the user interface is configured to present an orientation reference image comprising a human body adjacent to the 3D anatomical representation, wherein the orientation reference indicates an orientation of the human body that corresponds to a presented orientation of the 3D anatomical representation.

14. The device of claim 11, wherein the user interface is configured to:
receive a selection input from a user that selects one of the one or more anatomical structures; and
subsequently present a portion of the 3D model of the selected anatomical structure as the 3D anatomical representation.

15. The device of claim 14, wherein the one or more anatomical structures comprise one or more healthy anatomical structure and one or more diseased anatomical structure.

16. The device of claim 11, further comprising a processor configured to calculate a measurement of the measured portion of the 3D anatomical representation based on a measure input from one of a distance tool, an area tool, a volume tool, or an angle tool, wherein:
the measurement tools of the menu comprise at least one of the distance tool, the area tool, the volume tool, or the angle tool; and
the user interface is configured to receive a measure input that defines the measured portion of the 3D anatomical representation using one of the distance tool, the area tool, the volume tool, or the angle tool and present a visual identification of the measured portion of the 3D anatomical representation and a numerical calculation of the measurement.

17. The device of claim 11, wherein the user interface is configured to present a device representation in relation to the 3D anatomical representation, wherein the device representation is at least a portion of a 3D model of a medical device selected by a user.

18. The device of claim 17, wherein the user interface is configured to receive device modification input that modifies one or more characteristics of the selected medical device and present an updated device representation, further comprising a processor configured to update the 3D model based on the device modification input.

19. The device of claim 11, wherein the user interface is configured to present metadata related to the respective anatomical structure on which the presented 3D model is based, wherein the metadata comprises at least one of a height, a weight, a gender, an age, a health status, or imaging parameters associated with a patient associated with the respective anatomical structure.

20. A system comprising:
a data repository configured to store prepackaged anatomical data, wherein the prepackaged anatomical data comprises one or more pre-defined three-dimensional (3D) models of one or more respective anatomical structures;
a networked computing device configured to retrieve the prepackaged anatomical data from the data repository and transmit the prepackaged anatomical data to a user device via a network, wherein the user device comprises:
a communication module configured to receive the prepackaged anatomical data from the networked computing device; and
a user interface configured to present at least a portion of the one or more 3D models as a 3D anatomical representation, present a menu with the 3D anatomical representation, wherein the menu comprises manipulation control of the 3D anatomical representation and measurement tools, receive a manipulation control input, and manipulate the 3D anatomical representation according to the manipulation control input.

21. The system of claim 20, wherein:
the user interface is configured to receive a selection input from a user that selects one of the one or more anatomical structures and subsequently present a portion of the 3D model of the selected anatomical structure as the 3D anatomical representation; and
the communication module is configured to request prepackaged anatomical data comprising the selected anatomical structure from the networked computing device.

22. The system of claim 21, wherein the one or more anatomical structures comprise one or more healthy anatomical structure and one or more diseased anatomical structure.

23. The system of claim 20, wherein:
the user interface is configured to:
present a device representation in relation to the 3D anatomical representation, wherein the device representation is at least a portion of a 3D model of a medical device selected by a user;
receive device modification input that modifies one or more characteristics of the selected medical device; and
present an updated device representation; and
the user device comprises a processor configured to update the 3D model based on the device modification input.
